(19) United States
(12) Patent Application Publication
(10) Pub. No.: US 2005/0252493 A1
(43) Pub. Date: Nov. 17, 2005

(54) Fuel stop safety switch

(76) Inventor: Donald Joseph Simmons, East Berlin, CT (US)

Correspondence Address: DONALD J. SIMMONS, 790 SPRUCE BROOK ROAD, EAST BERLIN, CT, 06023, US

(21) Appl. No.: 10/844,007

(22) Filed: May 13, 2004

(51) Int. Cl. F02M 51/00; F02D 31/00

(52) U.S. Cl. 123/480; 123/198 DB; 123/198 D

(57) ABSTRACT

In order to fully understand how the Fuel Stop Safety Switch functions, it is essential for a general understanding of the normal function of the fuel injection system. We start with the driver pressing the accelerator pedal, this sends a command through it's throttle positioning sensor to the electronic control unit, which receives signals from various sensors and uses this data to determine the fuel needed to maintain efficient and normal operation of the vehicle. When the brake is applied it will activate the Fuel Stop Safety Switch, which will send a signal to the electronic control unit which will return the engine to the idle position, and will remain at idle position as long as the brake pedal is depressed. This will enable the driver to bring the automobile to a stop regardless of the drivers negligence in not removing his or her foot from the accelerator. This can be achieved in one of two ways, one is to install a Fuel Stop Safety Switch. The second way is to rewire the existing brake switch to send a signal to the electronic control unit.

### BACKGROUND OF THE INVENTION

There have been a number of fatal accidents involving Senior citizens. During several of these accidents both of the seniors feet were engaged at the same time, one on the brake the other on the accelerator. Naturally the power of the motor overrides the brake. Not only does this happen to older drivers but I am sure it happens to drivers in every age group. I have worked out the solution to this problem. The brake pedal which has approximately 1/2 inch free play will be equipped with an automatic device, limiting the amount of fuel delivered to the engine. This would prevent the vehicle from accelerating forward and in all probability prevent a fatal accident. The utilization of the existing mechanical controls with the Fuel Stop Safety Switch in conjunction with the present engine control would prevent this from happening.

### SUMMARY OF THE INVENTION

The utilization of the existing mechanisms in present day vehicles with a minimum of modification will enable the Fuel Stop Safety Switch to help prevent accidents. I am using the systems and controls presently existing, therefor it should be evident that the brake light switch and the electronic control unit, will be modified to create the Fuel Stop Safety Switch and the resulting action of this new concept.

The same principal, methods, and procedures that will be applied to the gas engine can also be adapted to the diesel engine, electric power vehicle, hydrogen or any type of vehicle where a brake pedal is used.

### DETAILED DESCRIPTION OF THE INVENTION

#-1 The purpose of the Fuel Stop Safety Switch is to limit the flow of fuel to the engine at the time of an emergency.

#-2 The manner in which this is achieved is by programming the fuel control module to limit the flow of fuel.

#-3 This is accomplished by using the free play which is at the initial engagement of the brake pedal. See drawing (A)

#-4 As the brake pedal is engaged, the flow of gas is automatically reduced as if lifting ones foot from the accelerator.

#-5 Due to this switch, it becomes impossible to feed more fuel to the motor. then what is required to keep the motor at idle.

### BRIEF DESCRIPTION OF THE DRAWINGS

These features and advantages of the Fuel Stop Safety Switch are described in connection with the accompanying drawings in which

FIG. 1A is a view of the brake pedal and the combination brake light and the Fuel Stop Safety Switch.

FIG. 2A is a view of the electronic control module and the programmable memory and the electrical harness.

### DETAILED DESCRIPTION OF THE PREFERRED EMBODIMENT

The drawings illustrate the two main components involved, the brake pedal and the electronic control module.

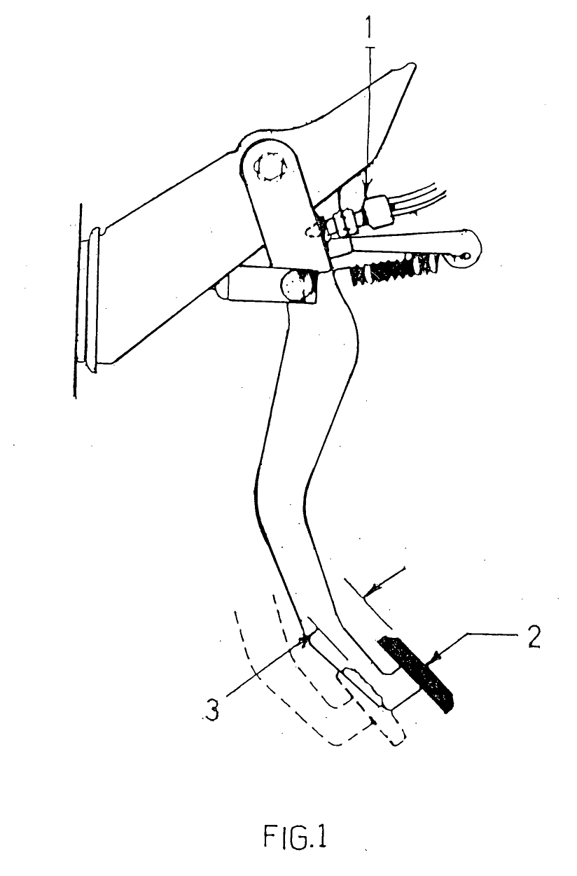

### FIG. 1A Detail (1)

### Combination Brake Light and Fuel Stop Safety Switch

By utilizing the brake switch, the electrical signal will not only control the brake lights, but also send a signal to the electronic control unit.

### FIG. 1A Detail (2)

Brake pedals current use is to bring the vehicle to a stop, it also controls brake light switch.

### FIG. 1A Detail (3)

Brake pedal free play is the amount of movement from the free state to the application of the brakes and activation of the brake lights and Fuel Stop Safety Switch.

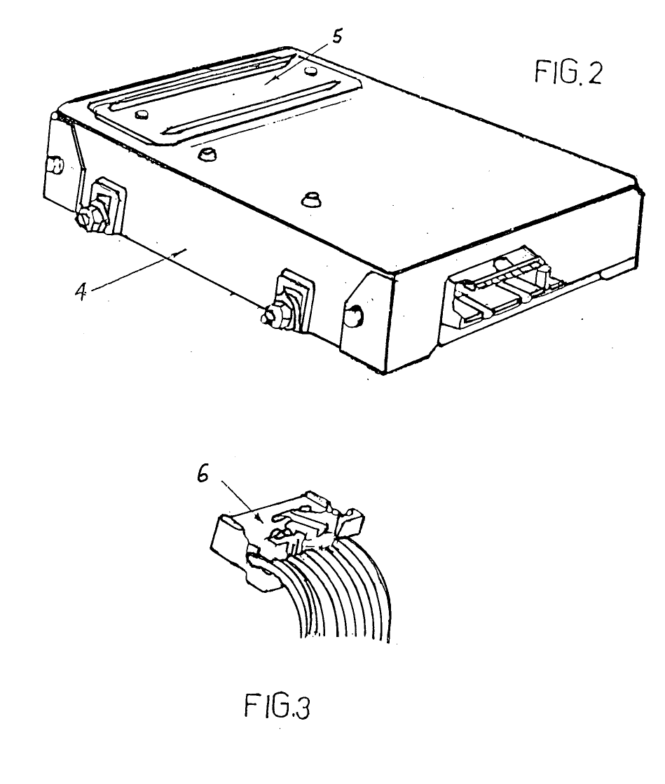

### FIG. 2A Detail (1)

### Utilization of the Electronic Control Module

In determining how much fuel is needed, the Electronic Control Module receives signals from sensors recording engine temperature, throttle position, vehicle speed, manifold vacuum and the exhaust oxygen content, along with this information, the unit will receive a signal from the Fuel Stop Safety Switch through the electrical wiring harness.

### FIG. 2A Detail (2)

### The Electrical Wiring Harness

The electrical wiring harness (2) receives signals from sensors. It will also receive a signal from the Fuel Stop Fuel Safety Switch and transmit this signal to the control module.

### FIG. 2A Detail (3)

### Programmable Memory

The Programmable Memory (3) interprets signals from the electronic control module. This will also include a signal from the Fuel Stop Safety Switch or the brake stop switch depending on which is used.

### Explanation of the Present Electronic Control Module

The Electronic Control Module (1) receives signals from sensors through the electrical harness (2) and the Programmable Memory, (3) interprets these signals and directs the operation of the fuel injection unit.

1. Will in all probability, help to prevent fatal accidents. It is a known fact, that as a person gets older they are not as mobile as a younger person, this leads to a reduction of mobility. therefore, an older person in time of emergency may have a serious problem. This is not to say that stepping on the brake and accelerator can not happen to anyone of any age in times of emergency. The Fuel Stop Safety Switch will alleviate this problem by eliminating human error in a emergency, allowing and helping the driver to come to a safe stop.
Police Pursuit Advantage of the Fuel Stop Switch

2. The FUEL STOP SAFETY SWITCH can also be used in conjunction with Car Star, On Star, Lojack and all registered trademarks. In this case, the Control Module would receive a signal from a satellite or G P S receiver, this would be the same signal that the vehicle now sends in the case of theft or accident. The signal could be programmed to activate the Control Module to reduce the flow of fuel to the idle position which could be used by the law enforcing authorities to apprehend the perpetrators. This would be especially useful in the case of pursuit, and would without doubt reduce the number of fatalities connected to police pursuit.
Snow or Mud Advantage of the Fuel Stop Safety Switch

3. Another use of the Fuel Stop Safety Switch would be the advantage to the driver in the case of being stuck in mud or snow.
Number #-1 Stepping on the brake pedal which will momentarily limit the fuel being delivered to the motor.
Number #-2 Depressing the accelerator part way.
Number #-3 Releasing the brake pedal.
Repeat steps number #1 #2 #3
This will crate the rocking motion that is needed to free the vehicle.
Faster Starts

4. The same procedure will be followed for a faster start. For a situation where faster then normal acceleration is required;
Number #-1 Press down on the brake pedal.
Number #-2 Apply pressure to the accelerator.
Number #-3 Release the brake pedal.
This procedure is to be utilized only when a quicker then normal acceleration is desired and is not recommended for normal driving.
